(19) United States
(12) Patent Application Publication
(10) Pub. No.: US 2008/0057286 A1
(43) Pub. Date: Mar. 6, 2008

(54) Method of forming a molded plastic article having at least one molded extension

(76) Inventors: Dale E. Polk, Titusville, FL (US); Albert H. Berghuis, Titusville, FL (US)

Correspondence Address: NOVA Chemicals Inc., Westpointe Center, 1550 Coraopolis Heights Road, Moon Township, PA, 15108, US

(21) Appl. No.: 11/512,792

(22) Filed: Aug. 30, 2006

(51) Int. Cl. B29C 45/16; B32B 27/04

(52) U.S. Cl. 428/299.1; 264/255

(57) ABSTRACT

In accordance with the present invention, there is provided a method of forming a molded plastic article having at least one molded extension extending from a second surface thereof, and a first surface that is substantially free of sink mark defects. The method involves providing a mold (1) that includes a first mold portion (11) having a recess (23) therein. At least a portion of the base (29) of the recess (23) is defined by the upper surface (44) of a part ejector (14). A first plastic material is introduced into the recess (23) so as to form a molded extension (47). After at least partial solidification of the molded extension (47), the part ejector (14) is positioned so as to push the upper surface (50) and upper portion (53) of the molded extension out of the recess (23), while a lower portion (56) of the molded extension remains within the recess. A second plastic material is introduced into the mold so as to form a molded body (59) in which the upper surface (50) and upper portion (53) of the molded extension (47) are immersed and embedded. The lower portion (56) of the molded extension extends from the second surface (62) of the molded body (59), and the first surface (65) of the molded body is substantially free of sink mark defects opposite the molded extension. The molded plastic article includes both the molded body (59) and molded extension (47). The present invention also relates to a molded plastic article.

### FIELD OF THE INVENTION

The present invention relates to a method of forming a molded plastic article having a second surface with at least one molded extension (e.g., a structural support, such as a rib) extending therefrom, and a first surface that is substantially free of sink mark defects. The molded article is formed using a mold that includes a first mold portion having a recess therein. At least a portion of the base of the recess is defined by the upper surface of a part ejector. A molded extension is formed within the recess from a first plastic material, and the part ejector is positioned so as to push the upper surface and upper portion of the molded extension out of the recess, while a lower portion of the molded extension resides within the recess. The upper surface and upper portion of the molded extension are immersed in a second plastic material that is introduced into the mold to form a molded body having first and second surfaces. The lower portion of the molded extension extends from the second surface of the molded body, and the first surface of the molded body is substantially free of sink mark defects opposite the molded extension. The molded article includes the molded body and molded extension. The present invention also relates to a molded plastic article as summarized above.

### BACKGROUND OF THE INVENTION

Many molded plastic articles are formed so as to include a cosmetic outer (or forward) surface and a noncosmetic inner (or rear/rearward) surface. Such a configuration allows a molded plastic article to be mounted to another structure (e.g., an underlying support structure, such as a frame) by means of the non-cosmetic rear surface without adversely affecting (e.g., damaging) the cosmetic forward surface. If in the form of a molded plastic housing (e.g., a computer or mobile phone housing), separate items, such as electronic components, may be secured to the inner non-cosmetic surface, without adversely affecting the outer cosmetic surface of the housing.

To assist mounting a molded plastic article to an underlying structure, or to secure items to the inside of a molded plastic housing, the rear or inner surface of the molded plastic article typically has molded extensions, e.g., molded mounting extensions such as posts and bosses, extending therefrom. For example, the molded article may be mounted on an underlying frame by means of fasteners, such as screws, passing through the frame and into the molded mounting extensions.

In many applications and industries in which molded plastic articles are used, it is desirable to reduce weight without compromising the structural integrity of the molded plastic article. Such weight sensitive applications and industries include, for example, transportation industries, such as the ground, marine, rail and air transportation industries, electronic industries, such as the computer, mobile phone and personal digital assistant industries, and construction industries (e.g., interior and exterior wall panels, and structure fascias). The weight of a molded plastic article may be reduced by reducing the amount of plastic material used to fabricate the molded article. Typically, the weight of a molded plastic article is reduced by making it thinner. To maintain the same level of dimensional stability and structural integrity relative to a thicker molded article, thinner molded articles are typically designed to include structural supports (e.g., ribs) extending from the non-cosmetic rear surface thereof.

Extensions, such as structural and/or mounting supports, extending from the rear surface of a molded plastic article are often undesirably accompanied by defects, such as sink marks in the outer or cosmetic forward surface of the molded article, or warping defects throughout at least a portion of the molded article. Sink mark defects are typically located on the forward surface opposite of the rearward extension. The defects are generally undesirable because of an accompanying reduction in cosmetic appearance (e.g., in the case of sink marks), and structural integrity (e.g., in the case of warping defects).

It would be desirable to develop new plastic molding methods that result in the formation of molded plastic articles having molded extensions, such as structural supports, extending from one surface, that are free of defects, such as sink marks, in the opposite surface thereof. It would be further desirable to develop molded plastic articles having molded extensions extending from one surface, and which are free of defects (e.g., sink marks) in the opposite surface thereof.

U.S. Pat. No. 6,551,540 B1 discloses a method of forming a molded vehicle component having structural ribs, that is free of visible sink marks. The method of US '540 is disclosed as involving first forming a primary vehicle component having structural ribs by injecting thermoplastic material into a first mold cavity. The mold is moved to form a second mold cavity, and additional thermoplastic material is injected therein so as to overmold the front face of the primary vehicle component, thus covering any sink marks in the front face.

U.S. Pat. No. 4,339,408 discloses a method of molding a hollow, plastic article having ribs extending from its walls. The method of US '408 involves first injecting plastic material into a mold to form a wall portion, and allowing the wall portion to cool in the mold. Next, additional plastic is injected into the rib forming cavity of the mold, the plastic material of the ribs is allowed to completely set, and the molded article having ribs is ejected from the mold.

U.S. Pat. No. 5,089,206 discloses a dual charge thermosetting compression molding method by which a molded article having ribs, and no sink mark defects, is formed. The method of US '206 is disclosed as involving placing a first charge of thermosetting plastic material that constitutes ribs into a mold, compressing the first charge, and opening the mold prior to complete cure of the first charge. A second charge of thermosetting plastic material is then placed in the mold, compressed, and the molded article is ejected from the mold. US '206 teaches that after the first compression, it is critical that residual unreacted monomers and oligomers remain in the first charge so as to chemically react with the second charge of plastic material, thereby forming a strong bond there-between.

United States Patent Application Publication No. US 2002/0172803 A1 discloses a method of forming a molded article having at least one compression molded plastic layer and at least one plastic projection extending from and bonded to the inner surface of the compression molded plastic layer. The method of US Application '803 involves first forming a plastic layer by compression molding, allowing the compression molded plastic layer to cool, and then forming plastic projections on the back surface of the compression molded plastic layer by injection molding methods.

### SUMMARY OF THE INVENTION

In accordance with the present invention there is provided, a method of forming a molded article having at least one molded extension (e.g., by injection or reaction injection molding) comprising:

(a) providing a mold comprising,
(i) a first mold portion having an interior surface comprising at least one recess defined by an internal sidewall surface and an internal base surface,
(ii) a part ejector having an upper surface and residing within said first mold portion, said part ejector being reversibly positionable between a first part ejector position and a second part ejector position, when in said first part ejector position said upper surface of said part ejector defining at least a portion of said internal base surface of said recess, when in said second part ejector position said upper surface of said part ejector extends into said recess, and
(iii) a second mold portion having an interior surface, said first mold portion and said second mold portion being reversibly positionable relative to each other;

(b) positioning said part ejector in said first part ejector position;

(c) introducing a first plastic material into said recess;

(d) allowing said first plastic material introduced into said recess to at least partially solidify, thereby forming a molded extension having an upper surface, an upper portion and a lower portion;

(e) positioning said first mold portion and said second mold portion such that the interior surface of said first mold portion and the interior surface of said second mold portion together define a mold cavity;

(f) positioning said part ejector into said second part ejector position, thereby moving said upper surface and said upper portion of said molded extension into said mold cavity, said lower portion of said molded extension residing within a portion of said recess;

(g) introducing a second plastic material into said mold cavity, said upper surface and said upper portion of said molded extension being immersed in said second plastic material introduced into said mold cavity, thereby forming a molded body comprising a first surface and a second surface; and

(h) removing said molded body from said mold, wherein the lower portion of said molded extension extends from said second surface of said molded body, said upper surface and said upper portion of said molded extension being fixedly embedded in said second plastic material of said molded body, said first surface of said molded body being substantially free of sink mark defects opposite each molded extension, and said molded article comprising said molded body and said molded extension.

In accordance with a further embodiment of the present invention, there is provided a method of forming a molded article having at least one molded extension (e.g., by compression molding) comprising:

(a) providing a mold comprising,
(i) a first mold portion having an interior surface comprising at least one recess defined by an internal sidewall surface and an internal base surface,
(ii) a part ejector having an upper surface and residing within said first mold portion, said part ejector being reversibly positionable between a first part ejector position and a second part ejector position, when in said first part ejector position said upper surface of said part ejector defining at least a portion of said internal base surface of said recess, when in said second part ejector position said upper surface of said part ejector extends into said recess, and
(iii) a second mold portion having an interior surface, said first mold portion and said second mold portion being reversibly positionable relative to each other;

(b) positioning said part ejector in said first part ejector position;

(c) introducing a first plastic material into said recess;

(d) allowing said first plastic material introduced into said recess to at least partially solidify, thereby forming a molded extension having an upper surface, an upper portion and a lower portion;

(e) positioning said part ejector in said second part ejector position, thereby moving said upper surface and said upper portion of said molded extension out of said recess, said lower portion of said molded extension residing within a portion of said recess;

(f) introducing a second plastic material into said first mold portion, such that said upper surface and said upper portion of said molded extension is immersed in the second plastic material introduced into said first mold portion;

(g) positioning said first mold portion and said second mold portion such that at least a portion of said interior surface of said second mold portion compressively contacts the second plastic material introduced into said first mold portion, thereby forming a molded body having a first surface and a second surface; and

(h) removing said molded body from said mold, wherein the lower portion of said molded extension extends from said second surface of said molded body, said upper surface and said upper portion of said molded extension being fixedly embedded in said second plastic material of said molded body, said first surface of said molded body being substantially free of sink mark defects opposite each molded extension, and said molded article comprising said molded body and said molded extension.

In accordance with the present invention, there is still further provided a molded article having at least one molded extension comprising:
(a) at least one molded extension having an upper surface, an upper portion and a lower portion, said molded extension being molded from a first plastic material; and
(b) a molded body comprising a first surface and a second surface, said molded body being molded from a second plastic material;
   wherein said upper surface and said upper portion of said molded extension is embedded in the second plastic material of said molded body, said lower portion of said molded extension extends from said second surface of said molded body, and said first surface of said molded body is substantially free of sink mark defects, opposite each molded extension.

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

As used herein and in the claims, terms of orientation and position, such as “upper”, “lower”, “inner”, “outer”, “right”, “left”, “vertical”, “horizontal”, “top”, “bottom”, and similar terms, are used to describe the invention as oriented in the drawings. Unless otherwise indicated, the use of such terms is not intended to represent a limitation upon the scope of the invention, in that the invention may adopt alternative positions and orientations.

Unless otherwise indicated, all numbers or expressions, such as those expressing structural dimensions, quantities of ingredients, etc. used in the specification and claims are understood as modified in all instances by the term “about”.

### BRIEF DESCRIPTION OF THE DRAWINGS

FIG. 1 is a representative sectional view of a mold apparatus used in the method of the present invention;

FIG. 2 is a representative sectional view of the mold apparatus of FIG. 1 with a first plastic material introduced into the recess in the first mold portion;

FIG. 3 is a representative sectional view of the mold apparatus of FIG. 2 in which the part ejector has been positioned into a second part ejector position, thus raising the upper surface and upper portion of the molded extension out of the recess and into the mold cavity;

FIG. 4 is a representative sectional view of the mold apparatus of FIG. 3 with a second plastic material introduced into the mold cavity;

FIG. 5 is a representative sectional view of a molded article according to the present invention;

FIG. 6 is a representative perspective view of a prior art molded article, having a molded extension, which exhibits both sink mark and warping defects;

FIG. 7 is a representative perspective view of a molded article according to the present invention that includes a molded extension in the form of a rib, and which further includes molded bosses and a molded post;

FIG. 8 is a representative sectional view of a mold (e.g., a compression mold) used in the method of the present invention in which a second plastic material has been introduced into the first mold portion, so as to immerse the upper surface and upper portion of the molded extension therein;

FIG. 9 is a representative sectional view of a mold apparatus similar to that depicted in FIG. 1, but in which the first and second mold portions are positioned so as to define an extension cavity, and the second mold portion includes an injection port aligned with the extension cavity; and

FIG. 10 is a representative perspective view of a molded article according to the present invention that includes a molded extension substantially in the form of a post.

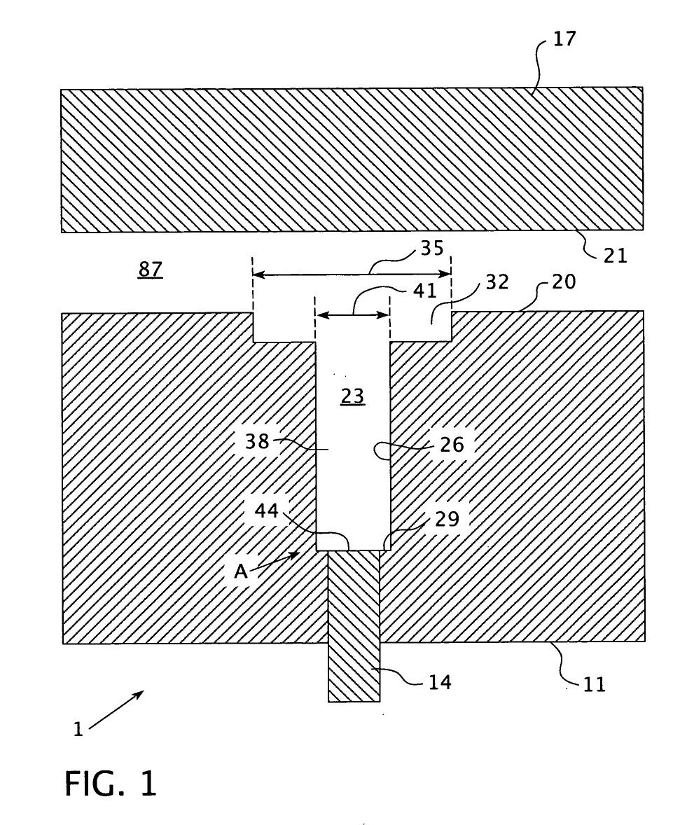

In FIGS. 1 through 10, like reference numerals designate the same components and structural features, unless otherwise indicated.

### DETAILED DESCRIPTION OF THE INVENTION

With reference to FIG. 1, the various embodiments of the method of the present invention involve providing a mold apparatus (or assembly) 1 that includes a first mold portion 11 having a reversibly positionable part ejector 14 therein, and a second mold portion 17 having an interior surface 21. First mold portion 11 has an interior surface 20, and also includes a recess 23, which is defined by an internal sidewall surface 26 and an internal base surface 29.

In the various embodiments of the method of the present invention, a molded extension is formed within recess 23, as will be discussed in further detail herein. Recess 23 may have any suitable shape provided that the molded extension that is formed therein is removable therefrom. For example, recess 23 (and the molded extension formed therein) may be substantially tubular having a cross sectional shape selected from circular shapes, oval shapes (e.g., elliptical shapes), polygonal shapes (e.g., triangular, rectangular—including squares, pentagonal, hexagonal, heptagonal, octagonal, etc.), irregular shapes, and combinations thereof. In addition, recess 23 (and the molded extension formed therein) may be elongated, for example in the form of an elongated slot or channel.

In an embodiment of the present invention, the recess of the first mold portion may have an upper portion having a larger dimension than a lower portion of the recess. For example, as depicted in FIG. 1, upper portion 32 of recess 23 has a lateral dimension 35 that is greater than the lateral dimension 41 of lower portion 38 of recess 23. Upper portion 32 and lower portion 38 of recess 23 may each independently have a cross sectional shape selected from circular shapes, oval shapes (e.g., elliptical shapes), polygonal shapes (e.g., triangular, rectangular, pentagonal, hexagonal, heptagonal, octagonal, etc.), irregular shapes, and combinations thereof. As depicted in FIG. 1, upper portion 32 of recess 23 has a cross arm shape. In three dimensions, upper portion 32 of FIG. 1 may have, for example, an elongated cross arm shape (e.g., extending into and/or out of the page), a plate-like shape (e.g., a disk shape) or combinations thereof. Lower portion 38 of recess 23 may, in three dimensions and independently of upper portion 32, have a tubular shape, an elongated shape (e.g., in the form of a slot extending into and/or out of the page) or combinations thereof.

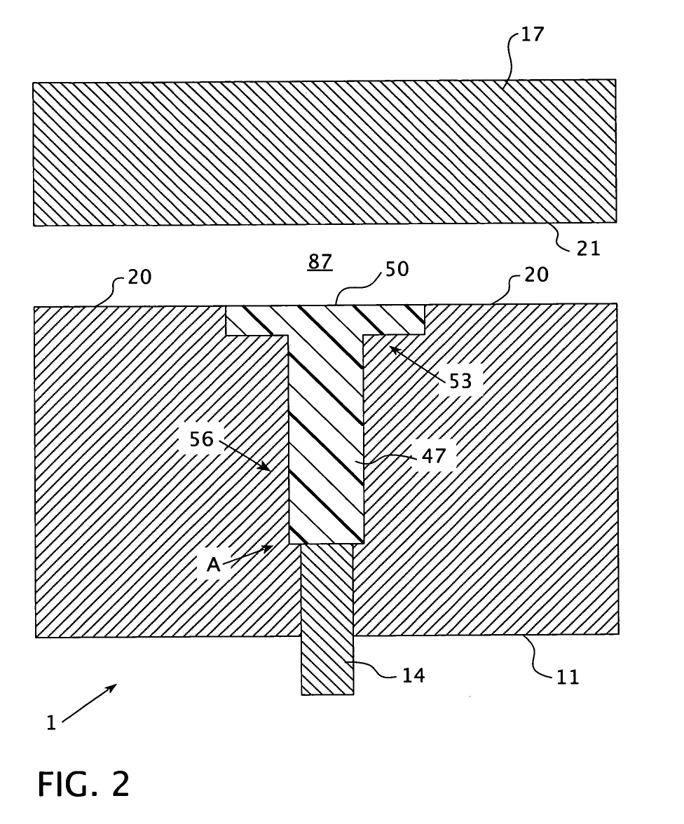

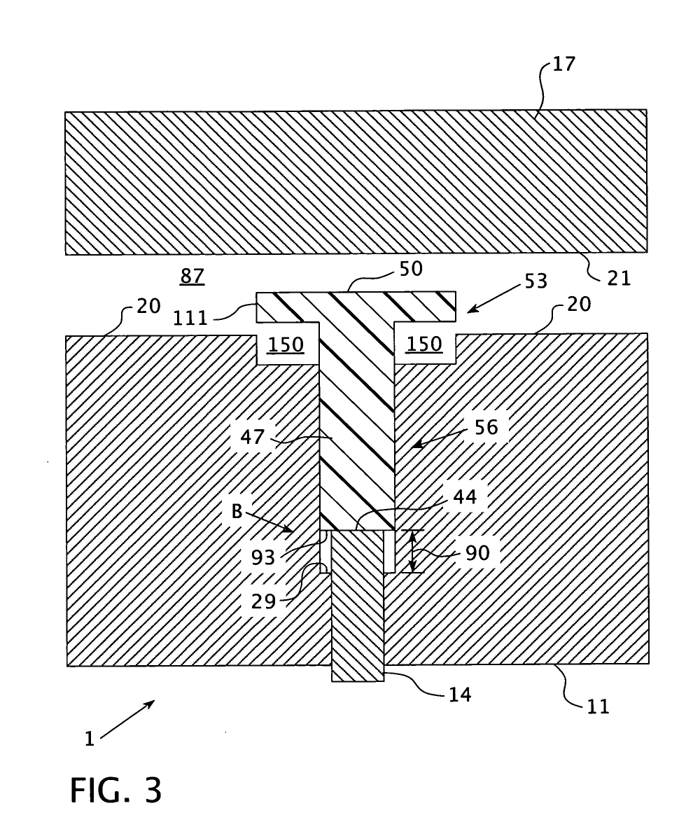

Part ejector 14 resides within first mold portion 11 and has an upper surface 44. Part ejector 14 is reversibly positionable between, at least, a first part ejector position A (FIGS. 1 and 2) and a second part ejector position B (FIG. 3). When in first part ejector position A, upper surface 44 of part ejector 14 defines at least a portion of internal base surface 29 of recess 23. Upper surface 44 of part ejector 14 may be flush (or even) with internal base surface 29 of recess 23, as depicted. Alternatively, when in the first part ejector position, upper surface 44 may reside above (or forward of), or below (or backward of) internal base surface 29, in which case upper surface 44 and internal base surface 29 together define an uneven internal base surface of recess 23. When in second part ejector position B, upper surface 44 of part ejector 14 is positioned or extends into recess 23. See, for example, FIG. 3. As used herein and in the claims, recitations as to the upper surface of the part ejector extending into the recess of the first mold portion (when in the second part ejector position) are inclusive of the upper surface of the part ejector extending further into the recess.

Part ejector 14 may be moved manually or mechanically between first and second part ejector positions A and B (and visa versa). Typically, part ejector 14 is moved mechanically, for example hydraulically by means of a drive-arm (not shown).

First mold portion 11 and second mold portion 17 are reversibly positionable relative to each other. One of first mold portion 11 or second mold portion 17 may be moveable, while the other is stationary. Alternatively, both first mold portion 11 and second mold portion 17 may be moveable. Typically, first mold portion 11 is stationary (e.g., relative to vertical movement) while second mold portion 17 is moveable (e.g., vertically) relative to first mold portion 11. The first and second mold portions may be reversibly positioned by known methods, for example, manually or mechanically. Typically, the mold portions are reversibly positioned by mechanical means, for example, by hydraulically driven drive-arms (not shown) along rails or tubular guides (not shown), in accordance with art-recognized methods.

The components of the mold apparatus used in the method of the present invention may be fabricated from suitable materials that are known to the skilled artisan. Typically, the components of the mold apparatus (e.g., the first mold portion, the second mold portion, and the part ejector) are fabricated from metals, such as steel (e.g., tool steel). The molding surfaces of the mold (e.g., the upper surface of the part ejector, the internal sidewall and base surfaces of the recess, and the interior surfaces of the first and second mold portions) may each independently be selected from polished steel surfaces, stainless steel surfaces, plated nickel surfaces, nickel/polytetrafluoroethylene surfaces and combinations thereof.

In the method of the present invention, part ejector 14 is positioned in first part ejector position A, such that upper surface 44 thereof defines at least a portion of internal base surface 29 of recess 23. A first plastic material is then introduced into recess 23. In the various embodiments of the method of the present invention, the first and second plastic materials are each separately and independently introduced into the mold (e.g., the recess, the mold cavity/cavities, or the first mold portion) in a fluid form (e.g., a free flowing granulated/particulate form, a liquid form or a molten form). When the plastic material is a thermoplastic material, it is typically introduced into the mold as a molten thermoplastic material having a temperature greater than the melting point thereof. If the plastic material is a thermosetting plastic material, it is typically introduced into the mold in a liquid form. If the first plastic material is in the form of a thermoplastic or thermosetting free flowing particulate material, it may be introduced into the mold in a free flowing particulate form, and subsequently transformed to a liquid or molten form by the application of elevated temperature.

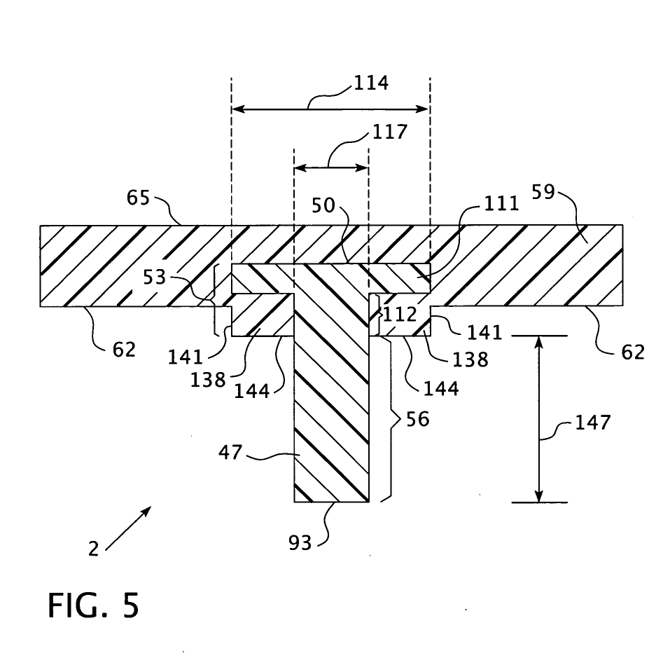

After introduction into recess 23, the first plastic material is allowed to at least partially solidify, thus forming a molded extension 47 (FIG. 2) of the molded article 2 (FIG. 5). Molded extension 47 includes an upper surface 50, an upper portion 53, a lower portion 56 and a base surface 93. With reference to FIG. 5, upper portion 53 of molded extension 47 is more particularly defined as that portion of molded extension 47 that is immersed and subsequently embedded in the second plastic material of the molded body 59 of the molded article 2 of the present invention. Correspondingly, lower portion 56 of molded extension 47 is more particularly defined as that portion of molded extension 47 that extends from second surface 62 of molded body 59.

In an embodiment of the present invention, at least a portion of the upper portion of the molded extension has a lateral dimension that is greater than the lateral dimension of the lower portion of the molded extension. With reference to FIG. 5, upper portion 53 of molded extension 47 has a substantially T-shaped cross-section, and lower portion 56 has a substantially extended rectangular cross-sectional shape. The cross arm portion 111 of the upper portion 53 of molded extension 47 has a lateral dimension 114 that is greater than the lateral dimension 117 of lower portion 56 thereof. Fabricating the molded extension such that at least a portion of the upper portion thereof has a lateral dimension that is greater than the lateral dimension of the lower portion thereof results in the upper portion of the molded extension being better anchored within the plastic material of the molded body. Improved anchoring of the molded extension results in improved dimensional stability of the molded article, as the molded extension is less likely to separate out of or change position relative to the molded body.

Allowing the first plastic material to at least partially solidify, and preferably substantially completely solidify, after introduction into the recess of the first mold portion, and prior to introduction of the second plastic material into the mold, as will be discussed further herein, is important for purposes of minimizing and preferably eliminating: (i) the occurrence of sink mark defects in the first (forward or exterior) surface 65 of the molded article 2; and optionally (ii) warping defects in the molded article of the present invention. When the first plastic material is a thermoplastic material, solidification thereof upon cooling below its melting point is typically accompanied by dimensional shrinkage. Some thermosetting plastic materials undergo dimensional shrinkage upon cure, while others undergo some dimensional expansion upon cure. While not intending to be bound by any theory, and based on the evidence at hand, it is believed that shrinkage of the plastic material results in formation of surface defects, such as sink marks, in the surface forward of (or opposite to) a thicker section of the molded article, such as a section that includes molded extensions. In addition, shrinkage and/or expansion of the plastic material may result in the formation of warping defects in such a forward surface and/or throughout other areas of the molded article.

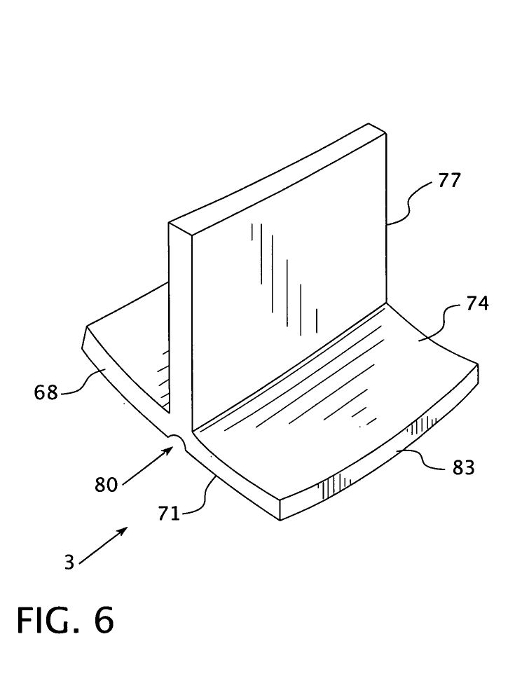

With reference to FIG. 6, and for purposes of illustration, there is depicted a prior art molded plastic article 3 that includes a base portion 68 having a first surface 71, a second surface 74, and a molded extension 77 extending from second surface 74 of base portion 68. Molded article 3 includes a sink mark defect 80 located in first surface 71 of base portion 68, and substantially opposite of molded extension 77. Sink mark defects are typically characterized by a depression (e.g., a conical depression) in the first (or forward) surface of a molded article, and are typically located opposite of a molded extension extending from the second (or rear) surface of the molded article. Molded article 3 also includes warping defects in first surface 71 and second surface 74 of base 68, which is observable along side 83 of base portion 68. Warping defects are typically characterized by bending or curvature of a portion of the molded article, which is usually, but not necessarily proximate to a molded extension. Molded article 3 is representative of a prior art unitary thermoplastic molded article in which molded extension 77 and base portion 68 are formed substantially concurrently during the molding process (e.g., injection or compression molding) and are continuous with each other.

The presence (or absence) of sink mark defects is typically determined and evaluated by visual inspection of the first surface of the molded article. Sink mark defects may also be identified and evaluated by more quantifiable methods. For example, alternatively or in addition to visual inspection, profile data (e.g., obtained using a profilometer) from the first surface of the molded article may be obtained and evaluated to determine the presence, location and degree of sink mark defects, in accordance with art-recognized methods. The presence (or absence) of warping defects is typically determined and evaluated by visual inspection of the molded article. In the case of flat surfaces, warping may be further determined and evaluated by means of a level (e.g., a bubble level) placed on various points of the molded surface. In the case of non-flat surfaces (e.g., curved surfaces), warping may be identified and evaluated by means of determining the degree of fit between the non-flat surface and a template placed in contact therewith, in accordance with art-recognized methods.

In an embodiment of the present invention, the first plastic material is a thermoplastic material, and after introduction into the mold (e.g., the recess or extension cavity—as will be discussed in further detail herein) and prior to introduction of the second plastic material into the mold, it is allowed to cool to a temperature T′ that represents a reduction below the melting point of the thermoplastic material that is at least 85 percent (e.g., at least 90 percent, or from 85 to 90 percent) of the difference between the melting point of the thermoplastic material and 25° C. The following Equation-I is provided for purposes of illustration.

T′=(Melting Point ° C.)−(x/100)(ΔA° C.) Equation-I

wherein ΔT=(Melting Point ° C.−25° C.)

In Equation I, the term “Melting Point” refers to the melting point of the thermoplastic material, which is greater than 25° C., and “x” represents a percent value from 0 to 100 percent (i.e., x is a number, including fractional numbers, from 0 to 100). For example, when the thermoplastic material of the first plastic material has a melting point of 137° C., Equation-I may be represented by the following Equation-II.

T′=(137° C.)−(x/100)(112° C.) Equation-II

With reference to Equation-II, when the thermoplastic material is allowed to cool to a temperature T′ that represents a reduction below the melting point of the thermoplastic material that is at least 85 percent of the difference between the melting point of the thermoplastic material and 25° C., x is 85, and accordingly T′ is 41.8° C. When the temperature reduction is 100 percent, x is 100, and accordingly T′ is 25° C.

In an embodiment of the present invention, the first plastic material is a thermoplastic material, which is allowed to substantially completely solidify prior to introduction of the second plastic material into the mold (e.g., into mold cavity 87 or first mold basin 129). Complete solidification may be achieved by allowing the thermoplastic material of the first plastic material to cool to a temperature T′ that represents a reduction below the melting point of the thermoplastic material that is 100 percent of the difference between the melting point of the thermoplastic material and 25° C. (i.e., T′=25° C.). Substantially complete solidification of the thermoplastic material of the first plastic material is desirable because it is typically accompanied by cessation of shrinkage thereof (i.e., shrinkage of the plastic material being substantially complete). Complete solidification of the first plastic material, however, may result in an undesirable increase in process cycle time, with an accompanying increase in production costs, due to increased cooling times.

In a further embodiment of the present invention, the first plastic material introduced into the mold (e.g., into recess 23 or extension cavity 99) is a thermoplastic material, which is allowed to cool to a temperature such that shrinkage of the first plastic material is substantially complete prior to introduction of the second plastic material in the mold (e.g., mold cavity 87 or first mold basin 129). Allowing the thermoplastic material of the first plastic material to cool to a temperature that is accompanied by substantially complete shrinkage is desirable when such temperature is greater than room temperature (e.g., >25° C.) for reasons that include reducing process cycle time and correspondingly reducing/optimizing related production costs. Such a temperature may be determined in accordance with Equation-I herein, in which x is 85 to 90, inclusive of the recited values.

Shrinkage of a plastic material as a function of temperature, and accordingly temperatures at which shrinkage of a plastic material is substantially complete, may be determined in accordance with art recognized methods. For example, temperatures at which shrinkage of the first plastic material is substantially complete may be determined in accordance with ASTM D 955-00. In addition, temperatures at which shrinkage is substantially complete may be determined experimentally by means of trial and error, for example, determining under what conditions a substantial absence of sink-mark defects is achieved.

In the plastic injection embodiment of the present invention, after or concurrent with at least partial solidification of the first plastic material in the recess of the first mold portion, first mold portion 11 and second mold portion 17 are positioned so as to define a mold cavity 87. More particularly, the mold portions are positioned such that interior surface 21 of second mold portion 17 and interior surface 20 of first mold portion 11 together define mold cavity 87.

Prior to, concurrent with or after positioning of the mold portions so as to define mold cavity 87, part ejector 14 is positioned into second part ejector position B. When in second part ejector position B, upper surface 44 of part ejector 14 extends or is positioned (optionally further) into recess 23 of first mold portion 11. With reference to FIG. 3, upper surface 44 of part ejector 14 is positioned or moved a distance 90 into recess 23, relative to the position of upper surface 44 when in first part ejector position A. Correspondingly, abutment between upper surface 44 of part ejector 14 and base surface 93 of molded extension 47 results in base surface 93 also being moved a distance 90 out of/further up into recess 23.

When in second part ejector position B, upper surface 50 and upper portion 53 of molded extension 47 are moved out of recess 23 and into mold cavity 87. In addition, when in second part ejector position B, lower portion 56 of molded extension 47 resides within a portion of recess 23.

In an embodiment of the present invention, second part ejector position B is selected such that: (i) upper surface 50 of molded extension 47 does not contact interior surface 21 of second mold portion 17; and (ii) lower portion 56 of molded extension 47 resides within a portion of recess 23. Avoiding contact of upper surface 50 of molded extension 47 with interior surface 21 of second mold extension 17 ensures that the upper surface and upper portion of the molded extension are fully immersed and embedded in the second plastic material of the molded body. In addition, avoiding contact between the upper surface of the molded extension and the interior surface of the second mold portion, further ensures that the first surface of the molded body (and correspondingly the first surface of the molded article) is formed from the second plastic material and defined by the interior surface of the second mold portion.

Maintaining lower portion 56 of molded extension 47 within a portion of recess 23 facilitates immersion of upper surface 50 and upper portion 53 thereof in the second plastic material that is introduced into the mold (e.g., mold cavity 87 or first mold basin 129). In particular, maintaining lower portion 56 within a portion of recess 23 provides stabilizing support for and positioning of upper surface 50 and upper portion 53 within mold cavity 87 during introduction of the second plastic material. Full immersion and embedding of the upper surface and upper portion of the molded extension in the second plastic material of the molded body is desirable as it improves the dimensional stability of the molded article of the present invention (e.g., the molded extension is better anchored within the molded body).

With the part ejector in second part ejector position B, and the upper surface and upper portion of the molded extension pushed out into the mold cavity, a second plastic material is introduced into the mold cavity. The upper surface and upper portion of the molded extension are immersed in the second plastic material that is introduced into the mold cavity (e.g., mold cavity 87). While the second plastic material may be introduced into the mold cavity at neutral or ambient (e.g., atmospheric) pressure, it is typically introduced at elevated pressure so as to facilitate substantially filling mold cavity 87 and immersing upper surface 50 and upper portion 53 of molded extension 47 therein. The pressure at which the second plastic material is introduced into the mold cavity generally depends in part on the viscosity of the second plastic material, e.g., a higher viscosity plastic material will typically require a higher injection pressure. In an embodiment of the present invention, the second plastic material is a thermoplastic material (e.g., thermoplastic polyethylene) which is introduced into mold cavity 87 at an injection pressure of from 1000 psi to 50,000 psi (70 to 3515 Kg/cm²), and more typically at a pressure of from 10,000 psi to 20,000 psi (703 to 1406 Kg/cm²).

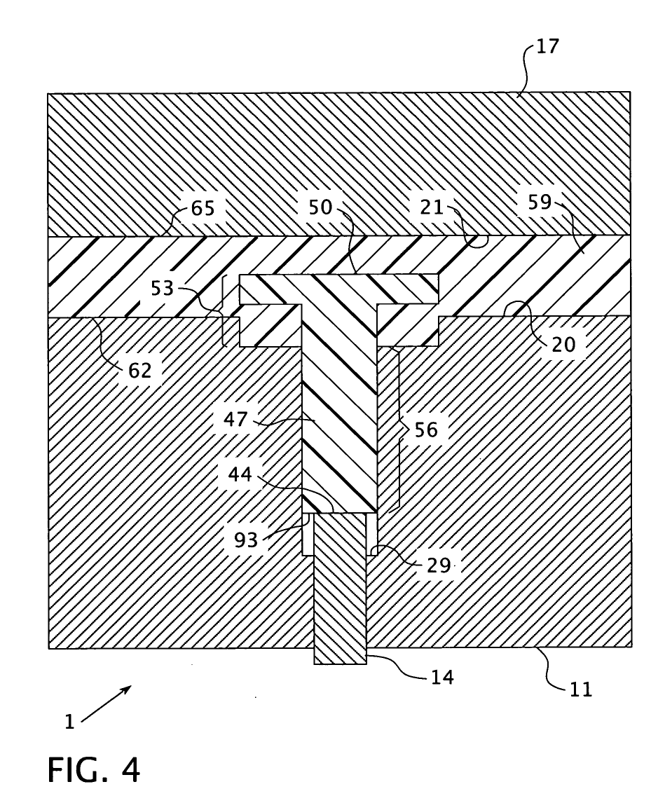

After introduction into mold cavity 87, the second plastic material is allowed to at least partially solidify, thus forming a molded body having a first surface and a second surface. With reference to FIGS. 4 and 5, molded body 59 has a first surface 65 and a second surface 62. As depicted by the representative sectional view of molded article 2 provided in FIGS. 4 and 5, upper surface 50 and upper portion 53 of molded extension 47 are embedded in the second plastic material of molded body 59.

After formation of molded body 59, molded article 2 is removed from the mold. For example, first mold portion 11 and second mold portion 17 are typically separated from each other, and molded article 2 is removed from first mold portion 11 by means of one or more ejector pins (not shown) pressing up against second surface 62 of molded body 59. Alternatively, or in addition to ejector pins, molded article 2 may be removed from first mold portion 11 by part ejector 14 being moved further into recess 23 (e.g., into a molded article ejection position—not shown). When in molded article ejection position, upper surface 44 of part ejector 14 is moved a distance into recess 23 that is greater than distance 90 of second part ejector position B (FIG. 3). As upper surface 44 of part ejector 14 is moved further into recess 23, base surface 93 of molded extension 47 is correspondingly moved further out of recess 23. Base surface 93 may be moved completely out of recess 23, or to an intermediate position which allows molded article 2 to be fully removed from first mold position 11 by art-recognized methods (e.g., by means of gravity, and/or manually or mechanically pulling the molded article out of the first mold portion).

The molded article (e.g., 2) prepared according to the methods of the present invention includes the molded body and the molded extension, the upper surface and portion of which are fixedly embedded in the second plastic material of the molded body. More particularly, lower portion 56 of molded extension 47 extends from second surface 62 of molded body 59. Upper surface 50 and upper portion 53 of molded extension 47 are fixedly embedded in the second plastic material of molded body 59. First surface 65 of molded body 59 is substantially free of sink mark defects, in particular opposite each molded extension. In addition, the molded article of the present invention is also typically substantially free of warping defects. The first surface of the molded article is defined by first surface 65 of molded body 59, and the second surface of the molded article is defined by second surface 62 of molded body 59.

Fusion (e.g., melt fusion) and/or covalent bond formation may occur between upper surface 50 and upper portion 53 of molded extension 47 and the second plastic material of molded body 59, in the method of the present invention. For example, if the first and second plastic materials are both thermoplastic materials, introduction of the second plastic material into the mold in a molten form may result in some melt-fusion upon contact thereof with first surface 50 and upper portion 53 of molded extension 47. For purposes of further illustration, if the first and second plastic materials are each thermosetting plastic materials, covalent bond formation may occur between first surface 50 and upper portion 53 of molded extension 47 and the second plastic material of molded body 59 when the second plastic material is introduced into the mold prior to complete cure of the first plastic material.

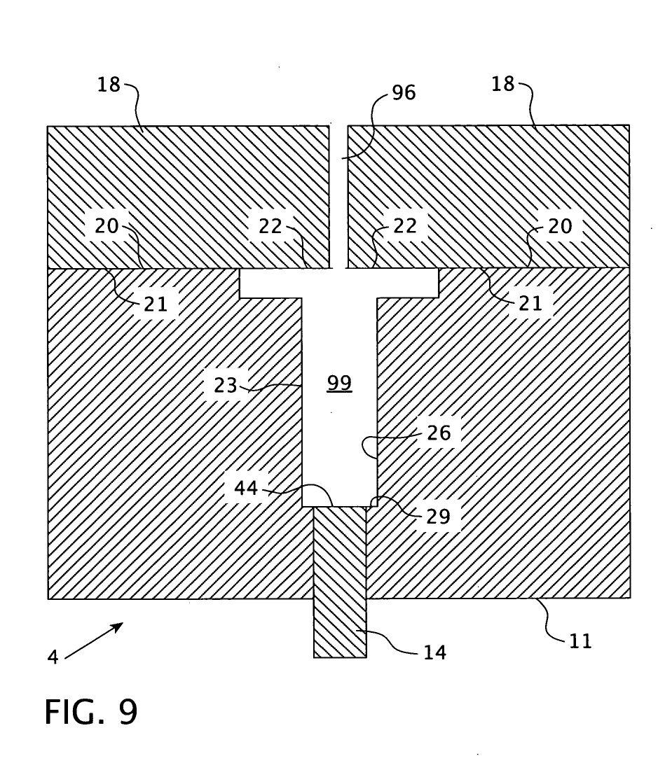

In an embodiment of the method of the present invention, the first and second mold portions are positioned so as to together form an extension cavity into which the first plastic material is introduced. With reference to FIG. 9, mold apparatus 4 includes first mold portion 11 and second mold portion 18 which are positioned in a first mold position such that internal sidewall surface 26 and internal base surface 29 of recess 23, and a portion 22 of interior surface 21 of second mold portion 18 together define an extension cavity 99. The first plastic material is then introduced into mold extension cavity 99, for example through injection channel 96. Formation of the extension cavity may be desirable for purposes of better controlling the formation of the upper surface of the molded extension, which is formed within the extension cavity. For example, when molded extension 47 is formed within extension cavity 99, upper surface 50 of the molded extension is formed against portion 22 of interior surface 21 of second mold portion 18. In an embodiment of the present invention, portion 22 of interior surface 20 of second mold portion 18 is uneven having raised and lowered features (not shown) that result in the formation of upper surface 50 having corresponding raised and lowered features that serve to enhance fixedly embedding upper surface 50 and upper portion 53 of molded extension 47 within the second plastic material of molded body 59.

When the recess of the first mold portion is open (e.g., as depicted in FIG. 1), the first plastic material is typically introduced into the recess at neutral or ambient pressure. In an embodiment of the present invention, when the first and second mold portions are positioned such that the internal sidewall and base surfaces of the recess and a portion of the interior surface of the second mold surface together define an extension cavity, the first plastic material may be introduced therein at ambient or elevated pressure. Elevated pressure may be employed, for example, so as to facilitate substantially filling the extension cavity. The pressure at which the first plastic material is introduced into extension cavity generally depends in part on the viscosity of the first plastic material, e.g., a higher viscosity plastic material will typically require a higher injection pressure. In an embodiment of the present invention, the first plastic material is a thermoplastic material (e.g., thermoplastic polyethylene), which is introduced into extension cavity 99 at an injection pressure of from 1000 psi to 50,000 psi (70 to 3515 Kg/cm²), and more typically at a pressure of from 10,000 psi to 20,000 psi (703 to 1406 Kg/cm²).

In the various embodiments of the method of the present invention, the first mold portion may include a plurality of recesses each having a part ejector that is reversibly positionable therein. A plurality of molded extensions are formed in the plurality of recesses. Accordingly, the molded article prepared by the method of the present invention may include a plurality of molded extensions, and the lower portion of each extension extends from the second surface of the molded body.

In an embodiment of the present invention, in addition to including at least one recess that includes a part ejector, the first mold portion (e.g., first mold portion 11) includes at least one recess (e.g., similar to recess 23) that does not include a part ejector (e.g., part ejector 14) therein. Such ejector-free recesses (not shown) result in the formation of molded extensions that do not include an upper surface and upper portion that are embedded in the plastic material of the molded body (i.e., non-embedded molded extensions). The non-embedded molded extensions may be formed by separately introducing first plastic material into the ejector-free recesses. More typically, the non-embedded molded extensions are formed concurrently with formation of the molded body when the second plastic material is introduced into the mold, and as such comprise the second plastic material and are continuous with the molded body. The introduction of the first plastic material into the ejector-free recesses may be prevented by, for example: covering the ejector-free recesses while first plastic material is introduced into the ejector-containing recesses; and/or simply not introducing first plastic material into the ejector-free recesses.

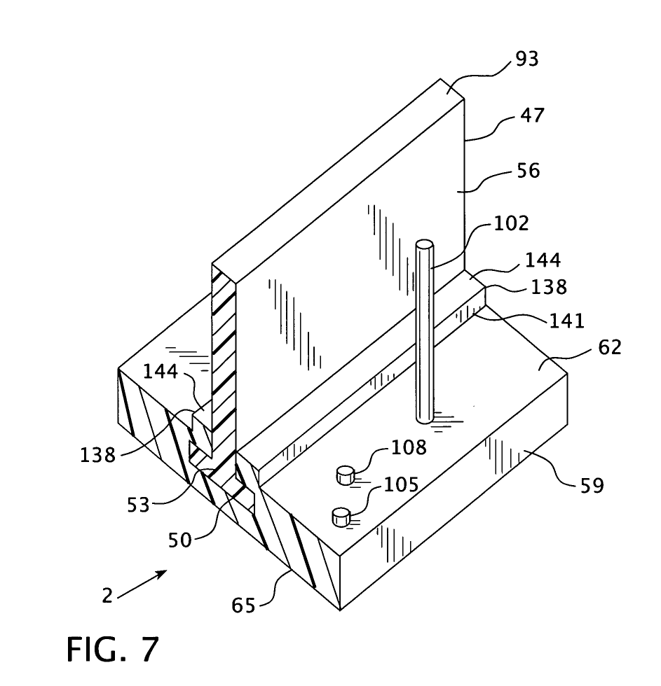

Examples of non-embedded molded extensions, include but are not limited to: structural supports, such as ribs (not shown) and posts (e.g., post 102); and mounting supports, such as bosses 105 and 108 of molded article 2 of FIG. 7. As such, in an embodiment of the present invention, the molded article further includes at least one non-embedded molded extension.

The molded extensions of the present invention may be selected from molded structural supports, molded mounting supports and combinations thereof. Structural supports provide the molded article with structural or dimensional stability, and include, but are not limited to, ribs and/or posts. Mounting supports provide a means by which the molded article may be attached to a separate article, such as a frame (e.g., an underlying space frame). A non-limiting example of a mounting support is a boss that may optionally include threading dimensioned for engagement with fasteners, such as bolts and screws. In some instances, a structural support may also serve as a mounting support. For example, a rib may also be used to attach the molded article to a separate article, such as a frame.

The first and second plastic materials that are introduced into the mold may each independently be selected from thermosetting plastic materials and/or thermoplastic materials. As used herein and in the claims the term “thermosetting plastic material” and similar terms, such as “thermoset plastic materials” means plastic materials having or that form a three dimensional crosslinked network resulting from the formation of covalent bonds between chemically reactive groups, e.g., active hydrogen groups and free isocyanate groups. Thermoset plastic materials from which the first and second plastic materials may each be independently selected, include those known to the skilled artisan, e.g., crosslinked polyurethanes, crosslinked polyepoxides and crosslinked polyesters (such as sheet molding compound compositions). The use of thermosetting plastic materials typically involves the art-recognized process of reaction injection molding. Reaction injection molding typically involves, as is known to the skilled artisan, injecting separately, and preferably simultaneously, into a mold: (i) an active hydrogen functional component (e.g., a polyol and/or polyamine); and (ii) an isocyanate functional component (e.g., a diisocyanate such as toluene diisocyanate, and/or dimers and trimers of a diisocyanate such as toluene diisocyanate). The filled mold may optionally be heated to ensure and/or hasten complete reaction of the injected components.

As used herein and in the claims, the term “thermoplastic material” and similar terms, means a plastic material that has a softening or melting point, and is substantially free of a three dimensional crosslinked network resulting from the formation of covalent bonds between chemically reactive groups, e.g., active hydrogen groups and free isocyanate groups. Examples of thermoplastic materials from which the first and second plastic materials may each be independently selected include, but are not limited to, thermoplastic polyurethane, thermoplastic polyurea, thermoplastic polyimide, thermoplastic polyamide, thermoplastic polyamideimide, thermoplastic polyester, thermoplastic polycarbonate, thermoplastic polysulfone, thermoplastic polyketone, thermoplastic polyolefins, thermoplastic(meth)acrylates, thermoplastic acrylonitrile-butadiene-styrene, thermoplastic styrene-acrylonitrile, thermoplastic acrylonitrile-stryrene-acrylate and combinations thereof (e.g., blends and/or alloys of at least two thereof).

In an embodiment of the present invention, the first and second plastic materials are each independently selected from thermoplastic polyolefins. As used herein and in the claims, the term “polyolefin” and similar terms, such as “polyalkylene” and “thermoplastic polyolefin,” means polyolefin homopolymers, polyolefin copolymers, homogeneous polyolefins and/or heterogeneous polyolefins. For purposes of illustration, examples of a polyolefin copolymers include those prepared from ethylene and one or more C₃-C₁₂ alpha-olefins, such as 1-butene, 1-hexene and/or 1-octene.

The polyolefins, from which the first and second plastic materials may each be independently selected, include heterogeneous polyolefins, homogeneous polyolefins, or combinations thereof. The term “heterogeneous polyolefin” and similar terms means polyolefins having a relatively wide variation in: (i) molecular weight amongst individual polymer chains (i.e., a polydispersity index of greater than or equal to 3); and (ii) monomer residue distribution (in the case of copolymers) amongst individual polymer chains. The term “polydispersity index” (PDI) means the ratio of M_{w}/Mₙ, where M_{w} means weight average molecular weight, and Mₙ means number average molecular weight, each being determined by means of gel permeation chromatography (GPC) using appropriate standards, such as polyethylene standards. Heterogeneous polyolefins are typically prepared by means of Ziegler-Natta type catalysis in heterogeneous phase.

The term “homogeneous polyolefin” and similar terms means polyolefins having a relatively narrow variation in: (i) molecular weight amongst individual polymer chains (i.e., a polydispersity index of less than 3); and (ii) monomer residue distribution (in the case of copolymers) amongst individual polymer chains. As such, in contrast to heterogeneous polyolefins, homogeneous polyolefins have similar chain lengths amongst individual polymer chains, a relatively even distribution of monomer residues along polymer chain backbones, and a relatively similar distribution of monomer residues amongst individual polymer chain backbones. Homogeneous polyolefins are typically prepared by means of single-site, metallocene or constrained-geometry catalysis. The monomer residue distribution of homogeneous polyolefin copolymers may be characterized by composition distribution breadth index (CDBI) values, which are defined as the weight percent of polymer molecules having a comonomer residue content within 50 percent of the median total molar comonomer content. As such, a polyolefin homopolymer has a CDBI value of 100 percent. For example, homogenous polyethylene/alpha-olefin copolymers typically have CDBI values of greater than 60 percent or greater than 70 percent. Composition distribution breadth index values may be determined by art recognized methods, for example, temperature rising elution fractionation (TREF), as described by Wild et al, Journal of Polymer Science, Poly. Phys. Ed., Vol. 20, p. 441 (1982), or in U.S. Pat. No. 4,798,081, or in U.S. Pat. No. 5,089,321. An example of homogeneous ethylene/alpha-olefin copolymers are SURPASS polyethylenes, commercially available from NOVA Chemicals Inc.

The first and second plastic materials may each independently and optionally include a reinforcing material selected, for example, from glass fibers, glass beads, carbon fibers, metal flakes, metal fibers, polyamide fibers (e.g., KEVLAR polyamide fibers), cellulosic fibers, nanoparticulate clays, talc and mixtures thereof. If present, the reinforcing material is typically present in a reinforcing amount, e.g., in an amount of from 5 percent by weight to 60 or 70 percent by weight, based on the total weight of the plastic material. The reinforcing fibers, and the glass fibers in particular, may have sizings on their surfaces to improve miscibility and/or adhesion to the plastic materials into which they are incorporated, as is known to the skilled artisan.

In an embodiment of the invention, the reinforcing material is in the form of fibers (e.g., glass fibers, carbon fibers, metal fibers, polyamide fibers, cellulosic fibers and combinations of two or more thereof. The fibers typically have lengths (e.g., average lengths) of from 0.5 inches to 4 inches (1.27 cm to 10.16 cm). The molded article of the present invention typically includes fibers having lengths that are at least 50 or 85 percent of the lengths of the fibers that are present in the feed materials from which the molded article is prepared, such as from 0.25 inches to 2 or 4 inches (0.64 cm to 5.08 or 10.16 cm). The average length of fibers present in the molded article may be determined in accordance with art recognized methods. For example, the molded article may be pyrolyzed to remove the plastic material, and the remaining or residual fibers microscopically analyzed to determine their average lengths, as is known to the skilled artisan.

Fibers are typically present in the first and/or second plastic materials in amounts independently from 5 to 70 percent by weight, 10 to 60 percent by weight, or 30 to 50 percent by weight (e.g., 40 percent by weight), based on the total weight of the plastic material (i.e., the weight of the plastic material, the fiber and any additives). Accordingly, the molded article of the present invention may include fibers in amounts of from 5 to 70 percent by weight, 10 to 60 percent by weight, or 30 to 50 percent by weight (e.g., 40 percent by weight), based on the total weight of the molded article.

The fibers may have a wide range of diameters. Typically, the fibers have diameters of from 1 to 20 micrometers, or more typically from 1 to 9 micrometers. Generally each fiber comprises a bundle of individual filaments (or monofilaments). Typically, each fiber is composed of a bundle of 10,000 to 20,000 individual filaments.

Typically, the fibers are uniformly distributed throughout the plastic material. During mixing of the fibers and the plastic material, the fibers generally form bundles of fibers typically comprising at least 5 fibers per fiber bundle, and preferably less than 10 fibers per fiber bundle. While not intending to be bound by theory, it is believed based on the evidence at hand, that fiber bundles containing 10 or more fibers may result in a molded article having undesirably reduced structural integrity. The level of fiber bundles containing 10 or more fibers per bundle, may be quantified by determining the Degree of Combing present within a molded article. The number of fiber bundles containing 10 or more fibers per bundle is typically determined by microscopic evaluation of a cross section of the molded article, relative to the total number of microscopically observable fibers (which is typically at least 1000). The Degree of Combing is calculated using the following equation: 100×((number of bundles containing 10 or more fibers)/(total number of observed fibers)). Generally, molded articles according to the present invention have a Degree of Combing of less than or equal to 60 percent, and typically less than or equal to 35 percent.

In addition or alternatively to reinforcing material(s), the first and second plastic materials may each independently and optionally include one or more additives. Additives that may be present in the first and/or second plastic material include, but are not limited to, antioxidants, colorants, e.g., pigments and/or dyes, mold release agents, fillers, e.g., calcium carbonate, ultraviolet light absorbers, fire retardants and mixtures thereof. Additives may be present in the plastic material in functionally sufficient amounts, e.g., in amounts independently from 0.1 percent by weight to 10 percent by weight, based on the total weight of the plastic material.

In an embodiment of the present invention, the first and second mold portions, and optionally the part ejector may optionally be further positioned so as to compress the first plastic material that has been introduced into the recess (e.g., recess 23) or the extension cavity (e.g., extension cavity 99). Alternatively, or in addition thereto, the first and second mold portions may be further positioned so as to compress the second plastic material that has been introduced into the mold cavity (e.g., mold cavity 87). Such optional post-injection compression of the first plastic material may be undertaken for purposes including, but not limited to: ensuring sufficient filling of recess 23 or extension cavity 99; and/or expelling entrapped gas (e.g., air) from the first plastic material. Likewise, optional post-injection compression of the second plastic material may be undertaken for purposes including, but not limited to: ensuring sufficient spreading of the plastic material over contact surfaces (e.g., interior surface 20 of first mold portion 11, interior surface 21 of second mold portion 17, and upper surface 50 and upper portion 53 of molded extension 47); and/or expelling entrapped gas (e.g., air) from the second plastic material. Entrapped gasses, such as air, may be removed from the mold during the optional compression step(s) by means of vents (not shown), as is known to the skilled artisan.

Post-injection compression of the first plastic material introduced into recess 23 or extension cavity 99 may be achieved by providing the internal surface of the second mold portion with a raised feature (not shown) extending out therefrom and being dimensioned to fit partially into recess 23 or extension cavity 99. For example, the raised feature may be dimensioned to fit partially into upper portion 32 of recess 23, such that when interior mold portion surfaces 21 and 20 are brought into abutment, the first plastic material previously introduced into recess 23 is compressed.

Post-injection compression of the first plastic material may also be achieved in an embodiment of the present invention by positioning the first and second mold portions such that the interior surfaces thereof are in abutting relationship, and moving part ejector 14 partially into recess 23 (or extension cavity 99) after introduction of the first plastic material therein. Moving part ejector 14 into recess 23/cavity 99 in this way reduces the volume of recess 23/cavity 99, and correspondingly results in compression of the previously introduced first plastic material. Moving part ejector 14 to compress the first plastic material within recess 23/cavity 99 involves positioning the part ejector in a compressive part ejector position (not shown), which is typically intermediate between first part ejector position A and second part ejector position B.

In accordance with the present invention there is further provided a method of forming a molded article by means of compression molding, that involves providing a mold apparatus substantially as described previously herein, for example mold apparatus 1 of FIG. 1. With the compression molding method of the present invention, mold apparatus 1 includes a first mold portion 11 having a reversibly positionable part ejector 14 therein, and a second mold portion 17 having an interior surface 21. First mold portion 11 has an interior surface 20, and also includes a recess 23, which is defined by an internal sidewall surface 26 and an internal base surface 29.

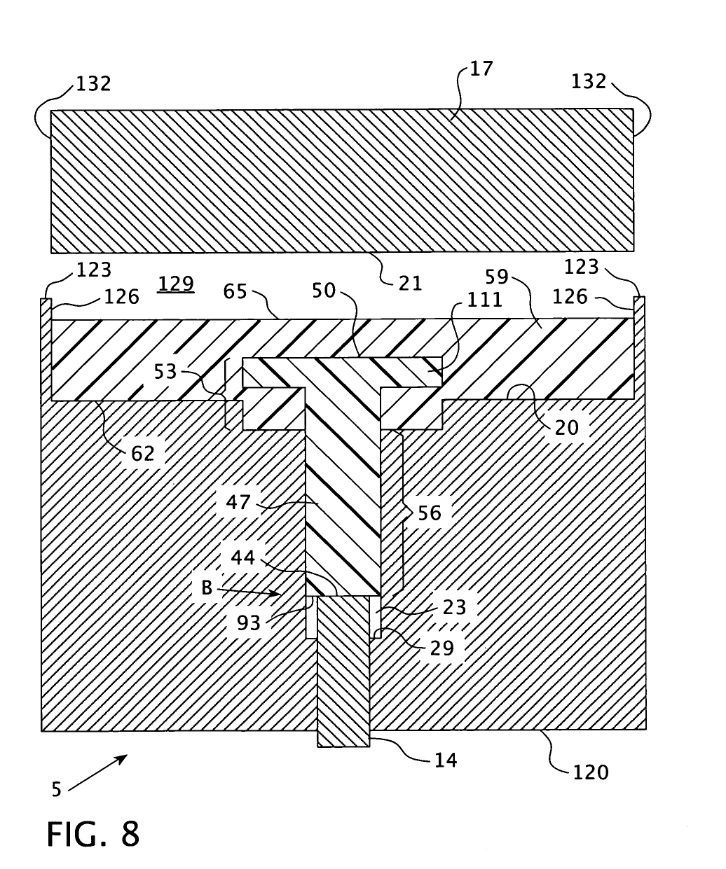

With the compression molding embodiment of the method of the present invention, and with reference to FIG. 8, first mold portion 11 may be replaced with first mold portion 120, which further includes a sidewall 123. Sidewall 123 extends upwardly relative to interior surface 20 of first mold portion 120. Internal surface 126 of sidewall 123 and interior surface 20 of first mold portion 120 together define a first mold basin 129. First mold basin 129 is dimensioned to receive second mold portion 17 during compressive contact between interior surface 21 of second mold portion 17 and the first and/or second plastic material introduced into first mold portion 120 (e.g., into recess 23 and/or first mold basin 129).

As described previously herein, part ejector 14 resides within the first mold portion (e.g., 11 or 120) and has an upper surface 44. Part ejector 14 is reversibly positionable between, at least, a first part ejector position A (FIGS. 1 and 2) and a second part ejector position B (FIGS. 3 and 8). When in first part ejector position A, upper surface 44 of part ejector 14 defines at least a portion of internal base surface 29 of recess 23. Upper surface 44 of part ejector 14 may be even (or flush) with internal base surface 29 of recess 23, as depicted. Alternatively, when in the first part ejector position, upper surface 44 may reside above (or forward of), or below (or backward of) internal base surface 29, in which case upper surface 44 and internal base surface 29 together define an uneven internal base surface of recess 23. When in second part ejector position B, upper surface 44 of part ejector 14 is positioned or extends into recess 23. See, for example, FIG. 3. As used herein and in the claims, recitations as to the upper surface of the part ejector extending into the recess of the first mold portion (when in the second part ejector position) are inclusive of the upper surface of the part ejector extending further into the recess.

Part ejector 14 may be moved manually or mechanically between first and second part ejector positions A and B (and visa versa). Typically, part ejector 14 is moved mechanically, for example hydraulically by means of a drive-arm (not shown).

The first mold portion (e.g., 11 or 120) and the second mold portion (e.g., 17) are reversibly positionable relative to each other, in the compression molding embodiment of the present invention. One of the first mold portion or the second mold portion may be moveable, while the other is stationary. Alternatively, both the first mold portion and the second mold portion may be moveable. Typically, the first mold portion is stationary (e.g., relative to vertical movement) while the second mold portion is moveable (e.g., vertically) relative to the first mold portion. The first and second mold portions may be reversibly positioned by known methods, for example, manually or mechanically. Typically, the mold portions are reversibly positioned by mechanical means, for example, by hydraulically driven drive-arms (not shown) along rails or tubular guides (not shown), in accordance with art-recognized methods.

The components of the mold apparatus used in the compression molding embodiment of the present invention may be fabricated from suitable materials that are known to the skilled artisan, and as described previously herein. Typically, the components of the mold apparatus (e.g., the first mold portion, the second mold portion, and the part ejector) are fabricated from metals, such as steel (e.g., tool steel). The upper surface of the part ejector, the internal sidewall and base surfaces of the recess, and the interior surfaces of the first and second mold portions (including the interior surfaces which define the first mold basin) may each independently be selected from polished steel surfaces, stainless steel surfaces, plated nickel surfaces, nickel/polytetrafluoroethylene surfaces and combinations thereof.

In the compression molding embodiment of the present invention, part ejector 14 is positioned in first part ejector position A, such that upper surface 44 thereof defines at least a portion of internal base surface 29 of recess 23. A first plastic material is then introduced into recess 23. In the various embodiments of the method of the present invention, the first and second plastic materials are each separately and independently introduced into the mold (e.g., the recess, the mold cavity/cavities, or the first mold portion) in a fluid form (e.g., a free flowing granulated/particulate form, a liquid form or a molten form). When the plastic material is a thermoplastic material, it is typically introduced into the mold (e.g., recess 23, extension cavity 99 or first mold basin 129) as a molten thermoplastic material having a temperature greater than the melting point thereof. If the plastic material is a thermosetting plastic material, it is typically introduced into the mold in a liquid form. If the first plastic material is in the form of a thermoplastic or thermosetting free flowing particulate material, it may be introduced into the mold in a free flowing particulate form, and subsequently transformed to a liquid or molten form by the application of elevated temperature.

The first and second plastic materials are typically introduced into first mold portion (e.g., 11 or 120), in the compression molding embodiment of the present invention, at ambient (or atmospheric) pressure. For example the first and second plastic materials are each typically introduced into (or deposited onto) first mold portion (e.g., first mold basin 129) by action of gravity from a position above the first mold portion (e.g., from the exit port of an extruder positioned above the first mold portion—not shown). To facilitate introduction of the first and second plastic materials, the first mold portion is typically reversibly and horizontally positionable (e.g., by shuttling along rails) between a plastic material introduction station (not shown), e.g., below the exit port of an extruder (not shown), and a compression station (not shown) where the first mold portion and the second mold portion are brought together so as to compress the plastic material introduced into the first mold portion (e.g., into recess 23 and/or first mold basin 129). While both the first and second mold portions may be reversibly vertically positionable in the compression station, the second mold portion (e.g., 17) is typically reversibly vertically positionable, while the first mold portion (e.g., 11 or 120) is substantially vertically stationary.

After introduction into the recess of the first mold portion, the first plastic material may be optionally compressed. Optional compression of the first plastic material within the recess (e.g., recess 23) may be achieved by positioning the first mold portion, the second mold portion and optionally the part ejector so as to compress the first plastic material introduced into said recess. Compression of the first plastic material may be undertaken for purposes including, but not limited to: ensuring sufficient filling of recess 23; and/or expelling entrapped gas (e.g., air) from the first plastic material. Entrapped gasses, such as air, may be removed from the mold during optional compression of the first plastic material by means of vents (not shown), as is known to the skilled artisan. After optional compression of the first plastic material within the recess is complete, the first and second mold portions are typically separated from each other, so as to allow for positioning of the part ejection into the second part ejector position, as will be discussed in further detail herein.

Optional compression of the first plastic material introduced into recess 23, in the compression molding embodiment of the present invention, may be achieved by providing the internal surface of the second mold portion with a raised feature (not shown) extending out therefrom and being dimensioned to fit partially into recess 23. For example, the raised feature may be dimensioned to fit partially into upper portion 32 of recess 23, such that when interior mold portion surfaces 21 and 20 are brought into abutment, the first plastic material previously introduced into recess 23 is compressed.

Optional compression of the first plastic material may also be achieved, in the compression molding embodiment of the present invention, by positioning the first and second mold portions such that the interior surfaces thereof are in abutting relationship, and moving part ejector 14 partially into recess 23 after introduction of the first plastic material therein. Moving part ejector 14 partially into recess 23 in this way reduces the volume of recess 23, and correspondingly results in compression of the previously introduced first plastic material. Moving part ejector 14 to compress the first plastic material within recess 23 involves positioning the part ejector in a compressive part ejector position (not shown), which is typically intermediate between first part ejector position A and second part ejector position B.

Optional compression of the first plastic material introduced into the recess of the first mold portion, in the injection and compression molding embodiments of the present invention, typically involves applying a compressive force to the first plastic material of from 25 psi to 550 psi (1.8 to 38.7 Kg/cm²), more typically from 50 psi to 400 psi (3.5 to 28.1 Kg/cm²), and further typically from 100 psi to 300 psi (7.0 to 21.1 Kg/cm²). The compressive force applied to the first plastic material may be constant or non-constant. For example, the compressive force applied to the first plastic material may initially ramp up at a controlled rate to a predetermined level, followed by a hold for a given amount of time, then followed by a ramp down to ambient pressure at a controlled rate. In addition, one or more plateaus or holds may be incorporated into the ramp up and/or ramp down during compression of the first plastic material.

After introduction into recess 23, and optionally during optional compression thereof, the first plastic material is allowed to at least partially solidify, thus forming molded extension 47 (FIG. 2) of the molded article 2 (FIG. 5). As discussed previously herein, molded extension 47 includes an upper surface 50, an upper portion 53, a lower portion 56 and a base surface 93. With reference to FIG. 5, upper portion 53 of molded extension 47 is more particularly defined as that portion of molded extension 47 that is immersed and subsequently embedded in the second plastic material of the molded body 59 of the molded article 2 of the present invention. Correspondingly, lower portion 56 of molded extension 47 is more particularly defined as that portion of molded extension 47 that extends from second surface 62 of molded body 59.

As discussed previously herein, at least a portion of the upper portion of the molded extension may optionally have a lateral dimension that is greater than the lateral dimension of the lower portion of the molded extension. With reference to FIG. 5, upper portion 53 of molded extension 47 has a substantially T-shaped cross-section, and lower portion 56 has a substantially extended rectangular cross-sectional shape. The cross arm portion 111 of the upper portion 53 of molded extension 47 has a lateral dimension 114 that is greater than the lateral dimension 117 of lower portion 56 thereof. The lateral dimension of the upper portion of the molded extension being greater than the lateral dimension of the lower portion thereof, provides for improved anchoring of the molded extension within the second plastic material of the molded body, which provides for a molded article having improved dimensional stability.

As discussed previously herein, allowing the first plastic material to at least partially solidify, and preferably substantially completely solidify, prior to introduction of the second plastic material into the mold, is important for purposes of minimizing and preferably eliminating: (i) the occurrence of sink mark defects in the first (forward or exterior) surface (e.g., 65) of the molded article (e.g., 2); and optionally (ii) warping defects in the molded article of the present invention.

In the compression molding embodiment of the present invention, the first plastic material may be a thermoplastic material, which is allowed to substantially completely solidify prior to introduction of the second plastic material into the mold (e.g., into first mold basin 129). Complete solidification may be achieved by allowing the thermoplastic material of the first plastic material to cool to a temperature T′ that represents a reduction below the melting point of the thermoplastic material that is 100 percent of the difference between the melting point of the thermoplastic material and 25° C. (i.e., T′=25° C.). See Equation-1 previously herein. Substantially complete solidification of the thermoplastic material of the first plastic material is desirable because it is typically accompanied by cessation of shrinkage thereof (i.e., shrinkage of the plastic material being substantially complete). Complete solidification of the first plastic material, however, may result in an undesirable increase in process cycle time, with an accompanying increase in production costs, due to increased cooling times.

In a further embodiment of the compression molding embodiment of the present invention, the first plastic material introduced into the mold (e.g., into recess 23) is a thermoplastic material, which is allowed to cool to a temperature such that shrinkage of the first plastic material is substantially complete prior to introduction of the second plastic material in the mold (e.g., first mold basin 129). Allowing the thermoplastic material of the first plastic material to cool to a temperature that is accompanied by substantially complete shrinkage is desirable when such temperature is greater than room temperature (e.g., >25° C.) for reasons that include, but are not limited to, reducing process cycle time and correspondingly reducing/optimizing related production costs. Such a temperature may be determined in accordance with Equation-I as discussed previously herein, in which x is 85 to 90, inclusive of the recited values.

After at least partial solidification of the first plastic material and formation of the molded extension, part ejector 14 is positioned into second part ejector position B. When in second part ejector position B, upper surface 44 of part ejector 14 extends or is positioned (optionally further) into the recess of the first mold portion. With reference to FIG. 3, upper surface 44 of part ejector 14 is positioned or moved a distance 90 into recess 23, relative to the position of upper surface 44 when in first part ejector position A. Correspondingly, abutment between upper surface 44 of part ejector 14 and base surface 93 of molded extension 47 results in base surface 93 also being moved a distance 90 out of (or up through) recess 23.

When in second part ejector position B in the compression molding embodiment, upper surface 50 and upper portion 53 of molded extension 47 are moved out of recess 23 and reside above interior surface 20 of the first mold portion (e.g., 11 or 120). For example, upper surface 50 and upper portion 53 of molded extension 47 are moved out of recess 23 and may reside in first mold basin 129 of first mold portion 120 (FIG. 8). In addition, when in second part ejector position B, lower portion 56 of molded extension 47 resides within a portion of recess 23.

In the compression molding embodiment of the present invention, second part ejector position B is typically selected such that: (i) upper surface 50 of molded extension 47 does not contact interior surface 21 of second mold portion 17 during compression of the second plastic material; and (ii) lower portion 56 of molded extension 47 resides within a portion of recess 23. Avoiding contact of upper surface 50 of molded extension 47 with interior surface 21 of second mold extension 17 ensures that the upper surface and upper portion of the molded extension are fully immersed and embedded in the second plastic material of the molded body. In addition, avoiding contact between the upper surface of the molded extension and the interior surface of the second mold portion, further ensures that the first surface of the molded body (and correspondingly the first surface of the molded article) is formed from the second plastic material and defined by the interior surface of the second mold portion.

Maintaining lower portion 56 of molded extension 47 within a portion of recess 23 facilitates immersion of upper surface 50 and upper portion 53 thereof in the second plastic material that is subsequently introduced into first mold portion (e.g., first mold basin 129). In particular, maintaining lower portion 56 within a portion of recess 23 provides stabilizing support for and positioning of upper surface 50 and upper portion 53 during introduction of the second plastic material into the first mold portion, and subsequent compression thereof. Full immersion and embedding of the upper surface and upper portion of the molded extension in the second plastic material of the molded body is desirable as it improves the dimensional stability of the molded article of the present invention (e.g., the molded extension is better anchored within the molded body).

With the part ejector in second part ejector position B, and the upper surface and upper portion of the molded extension pushed out of the recess and residing above the interior surface of the first mold portion, a second plastic material is introduced (e.g., poured) into the first mold portion (e.g., first mold basin 129 of first mold portion 120). The upper surface and upper portion of the molded extension are immersed in the second plastic material that is introduced into the first mold portion (e.g., first mold basin 129). In the compression molding embodiment, the second plastic material is typically introduced into the first mold portion at substantially neutral or ambient (e.g., atmospheric) pressure. Usually, the second plastic material is introduced into (or deposited onto) first mold portion (e.g., first mold basin 129) by action of gravity from a position above the first mold portion (e.g., from the exit port of an extruder positioned above the first mold portion—not shown).

After introduction of the second plastic material into the first mold portion, the first and second mold portions are positioned such that the interior surface of the second mold portion compressively contacts the second plastic material. With reference to FIG. 8, for example, the first and second mold portions may be positioned such that exterior side surfaces 132 of second mold portion 17 engage slidingly and sealingly with internal surfaces 126 of sidewalls 123 of first mold portion 120. The first and second mold portions are further positioned such that at least a portion of interior surface 21 of second mold portion 17 compressively contacts the second plastic material (e.g., first surface 65 thereof introduced into first mold basin 129 of first mold portion 120. Compression of the second plastic material ensures spreading thereof over interior surface 20 of the first mold portion, over interior surface 21 of second mold portion 17, and over upper surface 50 and around upper portion 53 of molded extension 47. In addition, compression of the second plastic material serves to expel gas, if any, entrapped within the plastic material (e.g., in the form of gas bubbles). To assist in the expulsion of gasses from the second plastic material, the mold apparatus is typically provided with vents (not shown), as is known to the skilled artisan.

The compressive force applied to the second plastic material introduced into first mold portion is typically from 25 psi to 550 psi (1.8 to 38.7 Kg/cm²), more typically from 50 psi to 400 psi (3.5 to 28.1 Kg/cm²), and further typically from 100 psi to 300 psi (7.0 to 21.1 Kg/cm²). The compressive force applied to the second plastic material may be constant or non-constant. For example, the compressive force applied to the second plastic material may initially be ramped up at a controlled rate to a predetermined level, followed by a hold for a given amount of time, then followed by a ramp down to ambient pressure at a controlled rate. In addition, and as previously described herein with regard to the first plastic material, one or more plateaus or holds may be incorporated into the ramp up and/or ramp down during compression of the second plastic material.

The second plastic material is allowed to at least partially solidify, after or concurrent with compression thereof, thus forming a molded body having a first surface and a second surface. As discussed previously herein with reference to FIGS. 4 and 5, molded body 59 has a first surface 65 and a second surface 62. As depicted by the representative sectional view of molded article 2 provided in FIGS. 4 and 5, upper surface 50 and upper portion 53 of molded extension 47 are embedded in the second plastic material of molded body 59.

After formation of molded body 59, molded article 2 (which includes the molded extension embedded within the molded body) is removed from the first mold portion. The molded article may be removed from the first mold portion in accordance with those methods described previously herein. For example, the first mold portion (e.g., 11 or 120) and second mold portion 17 are typically separated from each other, and molded article 2 is removed from the first mold portion by means of one or more ejector pins (not shown) pressing up against second surface 62 of molded body 59. Alternatively or in addition to ejector pins, part ejector 14 may be moved so as to abuttingly position base surface 93 of molded extension 47 further up into/out of recess 23, and thereby providing for removal of the molded article from the first mold portion.

As with the injection (or reaction injection) molding embodiment, the compression molding embodiment results in the formation of a molded article (e.g., 2) that includes a molded body having fixedly embedded therein the upper surface and upper portion of a molded extension. More particularly, and as described previously herein, lower portion 56 of molded extension 47 extends from second surface 62 of molded body 59. Upper surface 50 and upper portion 53 of molded extension 47 are fixedly embedded in the second plastic material of molded body 59. First surface 65 of molded body 59 is substantially free of sink mark defects, in particular opposite each molded extension. In addition, the molded article prepared in accordance with the compression molding embodiment of the present invention is also typically substantially free of warping defects. The first surface of the molded article is defined by first surface 65 of molded body 59, and the second surface of the molded article is defined by second surface 62 of molded body 59.

Fusion (e.g., melt fusion) and/or covalent bond formation may occur between upper surface 50 and upper portion 53 of molded extension 47 and the second plastic material of molded body 59, in the compression molding embodiment of the present invention. For example, if the first and second plastic materials are both thermoplastic materials, introduction of the second plastic material into the first mold portion (e.g., first mold basin 129) in a molten form may result in at least some melt-fusion upon contact thereof with first surface 50 and upper portion 53 of molded extension 47. In addition, if the first and second plastic materials are each thermosetting plastic materials, covalent bond formation may occur between first surface 50 and upper portion 53 of molded extension 47 and the second plastic material of molded body 59 when the second plastic material is introduced into the first mold portion prior (e.g., first mold basin 129) to complete cure of the first plastic material.

During the compression step, a portion of the second plastic material may be driven into surface voids that may be present in the upper surface and upper portion of the molded extension, thus further fixedly embedding the molded extension within the second plastic material of the molded body. Surface voids may form in the upper surface and upper portion of the molded extension as the result of the migration of entrapped gasses, such as air, to these surfaces.

In the compression molding embodiment of the present invention, the first and second plastic materials may each independently be selected from thermosetting plastic materials and/or thermoplastic materials. The thermosetting plastic materials and thermoplastic materials may each be independently selected from those classes and examples recited previously herein. In addition, the first and second plastic materials may each independently further include reinforcing material(s) and/or additive(s), which may be selected from those classes and examples, and be present in those amounts and ranges as recited previously herein,

In accordance with the present invention, there is also provided a molded article having at least one molded extension extending from the second surface of a molded body thereof, while the first surface thereof is substantially free of sink mark defects. The molded article may be described in accordance with the description provide previously herein with reference to FIG. 5. In particular, the molded article (e.g., 2) includes at least one molded extension 47 that has an upper surface 50, an upper portion 53, a lower portion 47 and a base surface 93. Upper surface 50 and upper portion 53 are embedded in the plastic material of the molded body 59. The lower portion 56 of molded extension 47 extends from second surface 62 of molded body 59. The first surface 65 of molded body 59 is substantially free of sink mark defects, in particular opposite of molded extension 47. Each molded extension is molded from a first plastic material, and the molded body is molded from a second plastic material.

The molded article according to the present invention may include a plurality of molded extensions. The lower portion of each molded extension extends from the second surface of the molded body of the molded article.

The molded extensions of the molded article of the present invention may be selected from molded structural supports, molded mounting supports and combinations thereof. Structural supports provide the molded article with structural or dimensional stability, and include, but are not limited to, ribs and/or posts. Mounting supports provide a means by which the molded article may be attached to a separate article, such as a frame (e.g., an underlying space frame). A non-limiting example of a mounting support is a boss that may optionally include internal and/or external threading dimensioned for engagement with fasteners, such as bolts and screws. A structural support may also serve as a mounting support. For example, a rib may also be used to attach the molded article to a separate article, such as a frame.

As depicted in FIG. 7, molded extension 47 is in the form of a rib (in particular an elongated rib), and has an upper surface 50 and an upper portion 53, which are embedded in the plastic material of molded body 59. Upper surface 50 and upper portion 53 as depicted in FIG. 7 extend back through molded body 59 contiguously with lower portion 56 of molded extension 47.

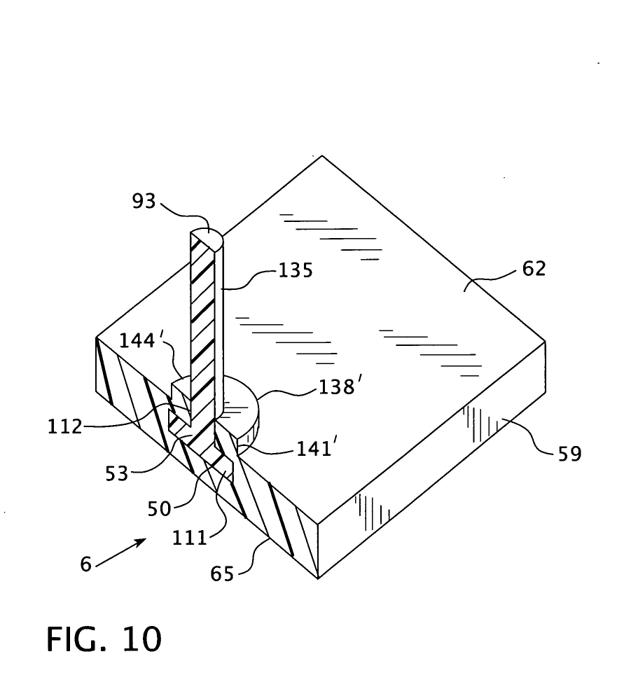

The molded extension of the molded article may be in the form of a post. With reference to FIG. 10, molded article 6 includes a molded extension 135 that is in the from of a post or rod extending from second surface 62 of molded body 59.

The molded body of the molded article of the present invention may further include at least one raised shoulder extending outward from the second surface of the molded body. The raised shoulder abuts a portion of the lower portion of the molded extension extending from the second surface of the molded body. In addition, the raised shoulder is continuous with the molded body and is molded from the second plastic material (from which the molded body is prepared). Accordingly, the molded body and the raised shoulder together form a continuous unitary molded piece. With reference to FIGS. 5 and 7, molded article 2 includes two raised shoulders 138 that each extend outwardly from second surface 62 of molded body 59. Each raised shoulder 138 abuts a portion of lower portion 56 of molded extension 47 which extends from second surface 62 of molded body 59. In FIG. 7, each raised shoulder 138 extends longitudinally and contiguously with lower portion 56 of molded extension rib 47.

Raised shoulder 138 has a sidewall 141 that extends outwardly from second surface 62 of molded body 59. In addition, shoulder 138 has a terminal surface 144, which resides a distance 147 from base surface 93 of molded extension 47. As depicted in FIG. 7, shoulder 138 extends along the longitudinal length of molded extension 47. Raised shoulder 138 is formed from second plastic material filling shoulder recess 150 (FIG. 3) when part ejector 14 is in second part ejector position B, and upper surface 50 and upper portion 53 of molded extension 47 are pushed out of upper portion 32 (FIG. 1) of recess 23. Shoulder recess 150 of FIG. 3 may represent two separate shoulder recesses (e.g., two separate elongated shoulder recesses) or a single (continuous or unitary) shoulder recess (e.g., an annular shoulder recess).

As the raised shoulder of the molded body is formed within the shoulder recess(es) of the recess of the first mold portion (e.g., shoulder recess(es) 150), it typically has a shape defined by the shoulder recess. The raised shoulder of the molded body may have a cross-sectional shape selected from semi-circles, semi-ovals, polygonal shapes (e.g., triangular, rectangular, square, pentagonal, hexagonal, heptagonal, octagonal shapes, etc.), and combinations thereof. Each raised shoulder may be an elongated raised shoulder, or may together form a continuous or unitary raised shoulder (e.g., an annular raised shoulder).

In an embodiment of the present invention, shoulder recess 150 is an annular shoulder recess in which an annular shoulder is formed. With reference to FIG. 10, molded article 6 includes an annular shoulder 138′ having a sidewall 141′ and a terminal surface 144′. Annular shoulder 138′ abuts a portion of molded extension 135, which extends from second surface 62 of molded body 59.

At least a portion of the upper portion of the molded extension may have a lateral dimension that is greater than the lateral dimension of the lower portion of the molded extension. The difference between the lateral dimensions of the upper and lower portions of the molded extension may be described in accordance with the description provided previously herein with reference to FIG. 5, cross arm portion 111, lateral dimension 114 and lateral dimension 117. In particular, cross arm portion 111 of upper portion 53 has a lateral dimension 114 that is greater than the lateral dimension 117 of lower portion 56 of molded extension 47 (FIG. 5). Compared to a molded extension having equivalent upper and lower lateral dimensions, the lateral dimension of the upper portion of the molded extension being greater than the lateral dimension of the lower portion thereof, provides for a molded extension that is better anchored within the plastic material of the molded body, and which correspondingly results in a molded article having improved dimensional stability since the molded extension is less likely to separate out of or change position relative to the molded body thereof.

The upper portion and the lower portion of the molded extension may each independently have a cross sectional shape selected from circular shapes, oval shapes (e.g., elliptical shapes), polygonal shapes (e.g., triangular, rectangular, pentagonal, hexagonal, heptagonal, octagonal, etc.), irregular shapes, and combinations thereof. The upper portion of the molded extension may have a symmetrical cross-sectional shape (e.g., a symmetrical T-shape) or an unsymmetrical cross-sectional shape (e.g., an unsymmetrical T-shape or an L-shape—not shown). As depicted in FIG. 5, upper portion 56 of molded extension 47 has a cross sectional T-shape. In three dimensions, upper portion 53 of FIG. 5 may have, for example, an elongated T-shape (e.g., extending into and/or out of the page), or a combination of a plate-like shape (e.g., a disk shape) and a rod-like shape. For purposes of illustration, cross arm portion 111 of upper portion may have a plate-like shape (e.g., in the form of a disk), while section 112 of upper portion 53 may have a tubular shape (e.g., in the form of a polygonal tube or a cylinder), for example as depicted in FIG. 10. Lower portion 56 of molded extension 47 may, in three dimensions and independently of upper portion 53, have a tubular shape, an elongated shape or combinations thereof.

The first and second plastic materials of the molded article may be selected from those classes and examples as described previously herein. For example, the first and second plastic materials may each be independently selected from thermosetting plastic materials and/or thermoplastic materials. In addition, the first and second plastic materials may optionally include reinforcing agents and/or additives selected from those classes and examples, and being present in amounts as described previously herein.

Molded articles that may be prepared according to the methods of the present invention, and according to the present invention, may be used in numerous industries, including for example, transportation (e.g., ground, air, marine and rail), computer, electronic, construction, and architectural industries. Transportation vehicles in which the molded articles of the present invention may be used, include, but are not limited to, automobiles, truck cabs, truck trailers, recreational vehicles, boats, ships, airplanes, rail road engines and rail cars. External vehicle panels that may comprise the molded articles of the present invention, include, for example, fenders, hoods, external door panels, rear decks (or trunk lids), and external truck trailer walls. Internal vehicle panels that may include the molded articles of the present invention, include, but are not limited to dashboard components, internal door panels, and cabinetry (e.g., in recreational vehicles). More particularly, in the marine industry, molded articles according to the present invention may be used to form boat/ship hulls having a smooth external surface (that contacts the water) and an internal surface having molded extensions (which may be used to attach the hull to other boat/ship structures). In the construction industry, molded articles of the present invention may be used as concrete forms. In the architectural industry, the molded articles of the present invention may be used as internal and external architectural panels, and office cubicle walls. Molded articles according to the present invention may be used as housings in the computer and electronics industries.

The present invention has been described with reference to specific details of particular embodiments thereof. It is not intended that such detailed be regarded as limitations upon the scope of the invention except insofar as and to the extent that they are included in the accompanying claims.

What is claimed is:

1. A method of forming a molded article having at least one molded extension comprising:
(a) providing a mold comprising,
(i) a first mold portion having an interior surface comprising at least one recess defined by an internal sidewall surface and an internal base surface,
(ii) a part ejector having an upper surface and residing within said first mold portion, said part ejector being reversibly positionable between a first part ejector position and a second part ejector position, when in said first part ejector position said upper surface of said part ejector defining at least a portion of said internal base surface of said recess, when in said second part ejector position said upper surface of said part ejector extends into said recess, and
(iii) a second mold portion having an interior surface, said first mold portion and said second mold portion being reversibly positionable relative to each other;
(b) positioning said part ejector in said first part ejector position;
(c) introducing a first plastic material into said recess;
(d) allowing said first plastic material introduced into said recess to at least partially solidify, thereby forming a molded extension having an upper surface, an upper portion and a lower portion;
(e) positioning said first mold portion and said second mold portion such that the interior surface of said first mold portion and the interior surface of said second mold portion together define a mold cavity;
(f) positioning said part ejector into said second part ejector position, thereby moving said upper surface and said upper portion of said molded extension into said mold cavity, said lower portion of said molded extension residing within a portion of said recess;
(g) introducing a second plastic material into said mold cavity, said upper surface and said upper portion of said molded extension being immersed in said second plastic material introduced into said mold cavity, thereby forming a molded body comprising a first surface and a second surface; and
(h) removing said molded body from said mold,
wherein the lower portion of said molded extension extends from said second surface of said molded body, said upper surface and said upper portion of said molded extension being fixedly embedded in said second plastic material of said molded body, said first surface of said molded body being substantially free of sink mark defects opposite each molded extension, and said molded article comprising said molded body and said molded extension.

2. The method of claim 1 further comprising, positioning said first mold portion and said second mold portion in a first mold position such that the internal sidewall surface of said recess, the internal base surface of said recess, and a portion of said interior surface of said second mold surface together define an extension cavity, and introducing said first plastic material into each extension cavity, thereby forming said molded extension.

3. The method of claim 1 wherein said first mold portion comprises a plurality of said recesses, and said molded article comprising a plurality of said molded extensions, the lower portion of each molded extension extending from said second surface of said molded body.

4. The method of claim 1 wherein said molded extension is selected from the group consisting of structural supports, mounting supports and combinations thereof.

5. The method of claim 4 wherein said structural supports are selected from the group consisting of ribs, posts and combinations thereof.

6. The method of claim 1 wherein at least a portion of said upper portion of said molded extension has a lateral dimension that is greater than a lateral dimension of said lower portion of said molded extension.

7. The method of claim 1 wherein said first plastic material and said second plastic material are each independently selected from the group consisting of thermosetting plastic materials, thermoplastic materials and combinations thereof.

8. The method of claim 7 wherein said first plastic material and said second plastic material are each independently a thermoplastic material selected from the group consisting of thermoplastic polyurethane, thermoplastic polyurea, thermoplastic polyimide, thermoplastic polyamide, thermoplastic polyamideimide, thermoplastic polyester, thermoplastic polycarbonate, thermoplastic polysulfone, thermoplastic polyketone, thermoplastic polyolefins, thermoplastic(meth)acrylates, thermoplastic acrylonitrile-butadiene-styrene, thermoplastic styrene-acrylonitrile, thermoplastic acrylonitrile-stryrene-acrylate and combinations thereof.

9. The method of claim 1 wherein at least one of said first plastic material and said second plastic material independently comprise a reinforcing material selected from the group consisting of glass fibers, glass beads, carbon fibers, metal flakes, metal fibers, polyamide fibers, cellulosic fibers, nanoparticulate clays, talc and mixtures thereof.

10. The method of claim 1 wherein said first plastic material is a thermoplastic material, and said method further comprising allowing said first plastic material introduced into said recess to substantially completely solidify prior to introduction of said second plastic material into said mold cavity.

11. The method of claim 1 wherein said first plastic material is a thermoplastic material, and said method further comprising allowing said first plastic material introduced into said recess to cool to a temperature at which shrinkage of said first plastic material is substantially complete, prior to introduction of said second plastic material into said mold cavity.

12. The method of claim 11 wherein said temperature is represented by the following equation,
T′=(Melting Point ° C.)−(x/100)(ΔT° C.)
wherein,
T′ is said temperature,
ΔT=(Melting Point ° C.)−(25° C.),
Melting Point being the melting point of said first plastic material, and
x is a number from 85 to 90.

13. The method of claim 1 further comprising at least one of:
(i) positioning said first mold portion and said second mold portion so as to compress said first plastic material introduced into said recess;
(ii) positioning said first mold portion, said second mold portion and said part ejector so as to compress said first plastic material introduced into said recess; and
(iii) positioning said first mold portion and said second mold portion so as to compress said second plastic material introduced into said mold cavity.

14. The method of claim 1 wherein said molded article is substantially free of warping defects.

15. A method of forming a molded article having at least one molded extension comprising:
(a) providing a mold comprising,
(i) a first mold portion having an interior surface comprising at least one recess defined by an internal sidewall surface and an internal base surface,
(ii) a part ejector having an upper surface and residing within said first mold portion, said part ejector being reversibly positionable between a first part ejector position and a second part ejector position, when in said first part ejector position said upper surface of said part ejector defining at least a portion of said internal base surface of said recess, when in said second part ejector position said upper surface of said part ejector extends into said recess, and
(iii) a second mold portion having an interior surface, said first mold portion and said second mold portion being reversibly positionable relative to each other;
(b) positioning said part ejector in said first part ejector position;
(c) introducing a first plastic material into said recess;
(d) allowing said first plastic material introduced into said recess to at least partially solidify, thereby forming a molded extension having an upper surface, an upper portion and a lower portion;
(e) positioning said part ejector in said second part ejector position, thereby moving said upper surface and said upper portion of said molded extension out of said recess, said lower portion of said molded extension residing within a portion of said recess;
(f) introducing a second plastic material into said first mold portion, such that said upper surface and said upper portion of said molded extension is immersed in the second plastic material introduced into said first mold portion;
(g) positioning said first mold portion and said second mold portion such that at least a portion of said interior surface of said second mold portion compressively contacts the second plastic material introduced into said first mold portion, thereby forming a molded body having a first surface and a second surface; and
(h) removing said molded body from said mold,
wherein the lower portion of said molded extension extends from said second surface of said molded body, said upper surface and said upper portion of said molded extension being fixedly embedded in said second plastic material of said molded body, said first surface of said molded body being substantially free of sink mark defects opposite each molded extension, and said molded article comprising said molded body and said molded extension.

16. The method of claim 15 further comprising,
positioning said first mold portion, said second mold portion and optionally said part ejector so as to compress said first plastic material introduced into said recess, and
separating said first mold portion and said second mold portion from each other prior to positioning said part ejector in said second part ejector position.

17. The method of claim 15 wherein said first mold portion comprises a plurality of said recesses, and said molded article comprising a plurality of said molded extensions, the lower portion of each molded extension extending from said second surface of said molded body.

18. The method of claim 15 wherein said molded extension is selected from the group consisting of structural supports, mounting supports and combinations thereof.

19. The method of claim 18 wherein said structural supports are selected from the group consisting of ribs, posts and combinations thereof.

20. The method of claim 15 wherein at least a portion of said upper portion of said molded extension has a lateral dimension that is greater than a lateral dimension of said lower portion of said molded extension.

21. The method of claim 15 wherein said first plastic material and said second plastic material are each independently selected from the group consisting of thermosetting plastic materials, thermoplastic materials and combinations thereof.

22. The method of claim 21 wherein said first plastic material and said second plastic material are each independently a thermoplastic material selected from the group consisting of thermoplastic polyurethane, thermoplastic polyurea, thermoplastic polyimide, thermoplastic polyamide, thermoplastic polyamideimide, thermoplastic polyester, thermoplastic polycarbonate, thermoplastic polysulfone, thermoplastic polyketone, thermoplastic polyolefins, thermoplastic(meth)acrylates, thermoplastic acrylonitrile-butadiene-styrene, thermoplastic styrene-acrylonitrile, thermoplastic acrylonitrile-stryrene-acrylate and combinations thereof.

23. The method of claim 15 wherein at least one of said first plastic material and said second plastic material independently comprise a reinforcing material selected from the group consisting of glass fibers, glass beads, carbon fibers, metal flakes, metal fibers, polyamide fibers, cellulosic fibers, nanoparticulate clays, talc and mixtures thereof.

24. The method of claim 15 wherein said first plastic material is a thermoplastic material, and said method further comprising allowing said first plastic material introduced into said recess to substantially completely solidify prior to introduction of said second plastic material into said first mold portion.

25. The method of claim 15 wherein said first plastic material is a thermoplastic material, and said method further comprising allowing said first plastic material introduced into said recess to cool to a temperature at which shrinkage of said first plastic material is substantially complete, prior to introduction of said second plastic material into said first mold portion.

26. The method of claim 25 wherein said temperature is represented by the following equation,
T′=(Melting Point ° C.)−(x/100)(ΔT° C.)
wherein,
T′ is said temperature,
ΔT=(Melting Point ° C.)−(25° C.),
Melting Point being the melting point of said first plastic material, and
x is a number from 85 to 90.

27. The method of claim 15 wherein said molded article is substantially free of warping defects.

28. A molded article having at least one molded extension comprising:
(a) at least one molded extension having an upper surface, an upper portion and a lower portion, said molded extension being molded from a first plastic material; and
(b) a molded body comprising a first surface and a second surface, said molded body being molded from a second plastic material;
wherein said upper surface and said upper portion of said molded extension is embedded in the second plastic material of said molded body, said lower portion of said molded extension extends from said second surface of said molded body, and said first surface of said molded body is substantially free of sink mark defects, opposite each molded extension.

29. The molded article of claim 28 wherein a plurality of said lower portions extend from said second surface of said molded body, and said molded article comprises a plurality of molded extensions.

30. The molded article of claim 28 wherein said molded extension is selected from the group consisting of structural supports, mounting supports and combinations thereof.

31. The molded article of claim 28 wherein said structural supports are selected from the group consisting of ribs, posts and combinations thereof.

32. The molded article of claim 28 wherein at least a portion of said upper portion of said molded extension has a lateral dimension that is greater than a lateral dimension of said lower portion of said molded extension.

33. The molded article of claim 28 wherein said molded body further comprises a raised shoulder extending outward from said second surface of said molded body, said raised shoulder abutting a portion of said lower portion of said molded extension extending from said second surface of said molded body, and said raised shoulder being continuous with said molded body and being molded from said second plastic material.

34. The molded article of claim 28 wherein said first plastic material and said second plastic material are each independently selected from the group consisting of thermosetting plastic materials, thermoplastic materials and combinations thereof.

35. The molded article of claim 34 wherein said first plastic material and said second plastic material are each independently a thermoplastic material selected from the group consisting of thermoplastic polyurethane, thermoplastic polyurea, thermoplastic polyimide, thermoplastic polyamide, thermoplastic polyamideimide, thermoplastic polyester, thermoplastic polycarbonate, thermoplastic polysulfone, thermoplastic polyketone, thermoplastic polyolefins, thermoplastic(meth)acrylates, thermoplastic acrylonitrile-butadiene-styrene, thermoplastic styrene-acrylonitrile, thermoplastic acrylonitrile-stryrene-acrylate and combinations thereof.

36. The molded article of claim 28 wherein at least one of said first plastic material and said second plastic material independently comprise a reinforcing material selected from the group consisting of glass fibers, glass beads, carbon fibers, metal flakes, metal fibers, polyamide fibers, cellulosic fibers, nanoparticulate clays, talc and mixtures thereof.

37. The molded article of claim 28 wherein said molded article is substantially free of warping defects.
